(19) United States
(12) Patent Application Publication
(10) Pub. No.: US 2021/0055519 A1
(43) Pub. Date: Feb. 25, 2021

(54) LENS GROUP, CAMERA MODULE AND MOTION CAMERA

(71) Applicant: JIANGXI LIANCHUANG ELECTRONICS CO, LTD., Nanchang (CN)

(72) Inventors: WENZHE WEI, Nanchang (CN); WEIJIAN CHEN, Nanchang (CN); XUMING LIU, Nanchang (CN); JIYONG ZENG, Nanchang (CN)

(21) Appl. No.: 16/941,576

(22) Filed: Jul. 29, 2020

Related U.S. Application Data
(63) Continuation-in-part of application No. PCT/CN2020/084659, filed on Apr. 14, 2020.

(30) Foreign Application Priority Data
Aug. 20, 2019 (CN) 201910766754.0

(51) Int. Cl. G02B 13/00; G02B 9/64; H04N 5/225

(52) U.S. Cl. CPC G02B 13/0045; G02B 9/64; H04N 5/2254; H04N 5/2253; G02B 13/006

(57) ABSTRACT

The disclosure provides a lens group, a camera module, and a motion camera. The lens group sequentially includes: a first lens and a second lens both having a negative refractive power, a convex object side surface, and a concave image side surface; a third lens with a negative refractive power and a concave object side surface; a fourth lens with a positive refractive power, and a convex object side surface; a stop; a fifth lens and a sixth lens both having a positive refractive power and a convex image side surface; a seventh lens with a negative refractive power, a concave object side surface, and a concave image side surface; an eighth lens with a positive refractive power, a convex object side surface, and a convex image side surface; and an optical filter. The sixth lens and the seventh lens form a cemented body.

### CROSS REFERENCE TO RELATED APPLICATION

This application is a continuation-in-part of International Application No. PCT/CN2020/084659, filed on Apr. 14, 2020, titled “OPTICAL IMAGING LENS AND IMAGING DEVICE”. The International application claims priority to a Chinese application No. 201910766754.0, filed on Aug. 20, 2019, titled “OPTICAL IMAGING LENS AND IMAGING DEVICE”, the entirety of which is incorporated by reference herein.

### TECHNICAL FIELD

The present disclosure relates to the field of lens imaging technology, in particular to a lens group, an imaging device, a camera module, and a motion camera.

### BACKGROUND

In the field of outdoor extreme sports, such as skiing, surfing, parachuting, diving, racing, etc., there are situations of severe vibration and rapid change of perspective. In these situations, there is a demand for a motion camera lens that is small in size and easy to carry, provides a relatively large range of field of view (FOV), and has good imaging effects and small distortion on photographing.

High resolution means smaller size of pixel and larger range of imaging plane. In this case, the higher and higher requirements for the resolution of the lens make it difficult to correct the marginal aberration of the lens.

Since that the motion camera detects optical signals and converts the optical signals into electrical signals by a chip, and the photosensitive range of the chip at short wavelengths is greater than that of human eyes, the secondary chromatic aberration needs a better correction.

### SUMMARY

The disclosure provides a lens group, an imaging device, a camera module, and a motion camera, which are capable of well correcting the aberration at the margin field, providing better imaging effects, and may be applied to imaging devices such as motion cameras.

The embodiments of the present disclosure provide the following technical solutions.

In a first aspect, the disclosure provides a lens group. From an object side to an imaging plane, the lens group sequentially includes: a first lens with a negative refractive power, a second lens with a negative refractive power, a third lens with a negative refractive power, a fourth lens with a positive reflective power, a stop, a fifth lens with a positive refractive power, a sixth lens with a positive refractive power, a seventh lens with a negative refractive power, an eighth lens with a positive refractive power, and an optical filter disposed between the eighth lens and the imaging plane. An object side surface of the first lens is a convex surface and an image side surface of the first lens is a concave surface; an object side surface of the second lens is a convex surface and an image side surface of the second lens is a concave surface; an object side surface of the third lens is a concave surface; an object side surface of the fourth lens is a convex surface; an image side surface of the fifth lens is a convex surface; an image side surface of the sixth lens is a convex surface; an object side surface and an image side surface of the seventh lens are both concave surfaces; an object side surface and an image side surface of the eighth lens are both convex surfaces. The sixth lens and the seventh lens are cemented into a cemented body.

The lens group satisfies the following expression:

−0.4<r₁₃/f₁₃+r₁₄/f₁₄<−0.1;

where r₁₃ represents a curvature radius of the image side surface of the seventh lens, r₁₄ represents a curvature radius of the object side surface of the eighth lens, f₁₃ represents a focal length of the image side surface the seventh lens, f₁₄ represents a focal length of the object side surface of the eighth lens.

In a second aspect, the disclosure provides an imaging device, including a lens group provided in the first aspect and an imaging element, wherein the imaging element is configured to convert optical images formed by the lens group into electrical signals.

In a third aspect, the disclosure provides a camera module, including a lens group and an image sensor coupled to the lens group, wherein the lens group is configured to form optical images, the image sensor is configured to convert the optical images in to electrical signals. From an object side surface to an imaging plane, the lens group sequentially comprises: a first lens having a negative refractive power, a convex object side surface, and a concave image side surface; a second lens having a negative refractive power, a convex object side surface, and a concave image side surface; a third lens having a negative refractive power and a concave object side surface; a fourth lens having a positive refractive power and a convex object side surface; a stop; a fifth lens having a positive refractive power and a convex image side surface; a doublet formed by a sixth lens and a seventh lens; an eighth lens having a positive refractive power, a convex object side surface, and a convex image side surface; an optical filter, disposed between the eighth lens and the imaging element. The sixth lens has a positive refractive power and a convex image side surface, the doublet has a concave image side surface.

The lens group satisfies the following expression:

−0.4<r₁₃/f₁₃+r₁₄/f₁₄<−0.1;

where r₁₃ represents a curvature radius of the image side surface of the seventh lens, r₁₄ represents a curvature radius of the object side surface of the eighth lens, f₁₃ represents a focal length of the image side surface the seventh lens, f₁₄ represents a focal length of the object side surface of the eighth lens.

In a fourth aspect, the disclosure provides a motion camera, including a camera module, a processor, and a memory, wherein the camera module includes a lens group and an image sensor coupled to the lens group, the camera module is configured to capture images, the processor is configured to process the captured images, and the memory is configured to store the captured images. The lens group from an object side to an imaging plane sequentially includes: a first lens having a negative refractive power, a convex object side surface, and a concave image side surface; a second lens having a negative refractive power, a convex object side surface, and a concave image side surface; a third lens having a negative refractive power and a concave object side surface; a fourth lens having a positive refractive power and a convex object side surface; a stop; a fifth lens having a positive refractive power and a convex image side surface; a sixth lens having a positive refractive power and a convex image side surface; a seventh lens having a negative refractive power, a concave object side surface, and a concave image side surface, the sixth lens and the seventh lens being cemented into a cemented body; an eighth lens having a positive refractive power, a convex object side surface, and a convex image side surface; an optical filter, disposed between the eighth lens and the image sensor. The lens group satisfies the expressions:

−0.4<r₁₃/f₁₃+r₁₄/f₁₄<−0.1;

TTL/BFL<6;

θ/IH²<0.25:

where r₁₃ represents a curvature radius of the image side surface of the seventh lens, r₁₄ represents a curvature radius of the object side surface of the eighth lens, f₁₃ represents a focal length of the image side surface the seventh lens, f₁₄ represents a focal length of the object side surface of the eighth lens, TTL represents a total length of the lens group, BFL represents a distance from a vertex of the image side surface of the eighth lens to the imaging plane, θ represents a half field of view of the lens group, IH represents an image height of the lens group at the half field of view θ.

Compared with the prior art, the lens group, the imaging device, the camera module, and the motion camera provided by the disclosure, the first lens, the second lens, and the third lens are configured for collecting lights and reducing the incident angle of the incident lights, which are conducive to reduce the volume of the lens group and facilitate a subsequent correction to the aberration thereof by an optical system. The image side surface of the second lens and the object side surface of the third lens bend towards opposite directions, which may effectively reduce the total length of the lens group. The third lens and the fourth lens are configured for eliminating the field curvature cooperatively with each other. The fourth lens has a positive refractive power which is beneficial to the reduction of the spherical aberration and the axial chromatic aberration. The fifth lens and the sixth lens adopt glass materials with large deviation values of relative partial dispersion, which is benefit to correct the secondary spectrum, thereby enabling the optical system may have better imaging effects in a relatively wide range of visible light. The cemented body formed by the sixth lens and the seventh lens may effectively correct the chromatic aberration. The eighth lens is configured to eliminate the aberration and control the exit angle of the main rays. Since the seventh lens and the eighth lens are close to the imaging plane, the ghost, occurred by lights reflected by the seventh lens and the eighth lens, may be easily focused on the imaging plane. By satisfying the expression: −0.4<r₁₃/f₁₃+r₁₄/f₁₄<−0.1, the ghost occurred by the secondary reflection of the seventh lens and the eighth lens may be effectively eliminated.

These or other aspects of the disclosure will become more apparent and more understandable in the description of the following embodiments.

### BRIEF DESCRIPTION OF THE DRAWINGS

FIG. 1 is a schematic structural diagram of a lens group according to a first embodiment of the present disclosure;

FIG. 2 is a field curvature diagram of the lens group according to the first embodiment;

FIG. 3 is a lateral chromatic aberration diagram of the lens group according to the first embodiment;

FIG. 4 is a schematic structural diagram of a lens group according to a second embodiment;

FIG. 5 is a field curvature diagram of the lens group according to the second embodiment;

FIG. 6 is a lateral chromatic aberration diagram of the lens group according to the second embodiment;

FIG. 7 is a schematic structural diagram of a lens group according to a third embodiment;

FIG. 8 is a field curvature diagram of the lens group according to the third embodiment;

FIG. 9 is a lateral chromatic aberration diagram of the lens group according to the third embodiment;

FIG. 10 is a schematic structural diagram of a lens group according to a fourth embodiment;

FIG. 11 is a field curvature diagram of the lens group according to the fourth embodiment;

FIG. 12 is a lateral chromatic aberration diagram of the lens group according to the fourth embodiment;

FIG. 13 is a schematic structural diagram of a lens group according to a fifth embodiment;

FIG. 14 is a field curvature diagram of the lens group according to the fifth embodiment;

FIG. 15 is a lateral chromatic aberration diagram of the lens group according to the fifth embodiment;

FIG. 16 is a schematic structural diagram of a lens group according to a sixth embodiment;

FIG. 17 is field curvature diagram of the lens group according to the sixth embodiment;

FIG. 18 is a lateral chromatic aberration diagram of the lens group according to the sixth embodiment;

FIG. 19 is a schematic structural diagram of a lens group according to a seventh embodiment;

FIG. 20 is a field curvature diagram of the lens group according to the seventh embodiment;

FIG. 21 is a lateral chromatic aberration diagram of the lens group according to the seventh embodiment;

FIG. 22 is a schematic structural diagram of lens group according to an eighth embodiment;

FIG. 23 is a field curvature diagram of the lens group according to the eighth embodiment;

FIG. 24 is a lateral chromatic aberration diagram of the lens group according to the eighth embodiment;

FIG. 25 is a schematic structural diagram of an imaging device according to ninth embodiment;

FIG. 26 is schematic structural diagram showing a cross-section of a camera module according to tenth embodiment;

FIG. 27 is a bock diagram of motion camera according to an eleventh embodiment.

### MAIN REFERENCE NUMERALS

| first lens | L1 | second lens | L2 |
|---|---|---|---|
| third lens | L3 | fourth lens | L4 |
| fifth lens | L5 | sixth lens | L6 |
| seventh lens | L7 | eighth lens | L8 |
| stop | ST | optical filter | G1 |
| object side surface of the first lens | S1 | image side surface of the first lens | S2 |
| object side surface of the second lens | S3 | image side surface of the second lens | S4 |
| object side surface of the third lens | S5 | image side surface of the third lens | S6 |
| object side surface of the fourth lens | S7 | image side surface of the fourth lens | S8 |
| object side surface of the fifth lens | S9 | image side surface of the fifth lens | S10 |
| object side surface of the sixth lens | S11 | image side surface of the sixth lens | S12-1 |
| object side surface of the seventh lens | S12-2 | image side surface of the seventh lens | S13 |
| object side surface of the eighth lens | S14 | image side surface of the eighth lens | S15 |
| object side surface of the optical filter | S16 | image side surface of the optical filter | S17 |
| imaging plane | S18 | cemented surface of the sixth lens and the seventh lens | S12 |
| lens group | 100, 200, 300, 400, 500, 600, 700, 800, 1010 | | |
| imaging device | 900 | imaging element | 910 |
| camera module | 1000 | barrel | 1001 |
| holder | 1002 | image sensor | 1003 |
| printed circuit board | 1004 | motion camera | 1100 |
| processor | 1110 | memory | 1120 |

The present disclosure will be further illustrated by the following specific embodiments in combination with the above accompanying drawings.

### DETAILED DESCRIPTION OF PREFERRED EMBODIMENTS

In order to facilitate the understanding of the present disclosure, the present disclosure will be illustrated in an embodiment in combination with accompanying drawings of associated embodiments. However, the disclosure is not limited to the above preferred embodiments. Rather, these embodiments are provided to make the disclosure more sufficient.

Unless defined otherwise, all technical terms and scientific terms used herein have the same meaning as commonly understood by one of ordinary skill in the art to which this disclosure belongs. The terminology used herein in the description of the disclosure are only for the purpose of describing specific embodiments, and is not intended to limit the disclosure. The term “and/or” as used herein includes any and all combinations of one or more of the associated listed items.

The embodiments of the disclosure provide a lens group. From an object side to an imaging plane, the lens group sequentially includes: a first lens with a negative refractive power, a second lens with a negative refractive power, a third lens with a negative refractive power, a fourth lens with a positive refractive power, a stop, a fifth lens with a positive refractive power, a sixth lens with a positive refractive power, a seventh lens with a negative refractive power, an eighth lens with a negative refractive power, and an optical filter disposed between the eighth lens and the optical filter. An object side surface of the first lens is a convex surface, an image side surface of the first lens is a concave surface. An object side surface of the second lens is a convex surface, an image side surface of the second lens is a concave surface. An object side surface of the third lens is a concave surface. An object side surface of the fourth lens is a convex surface. An image side surface of the fifth lens is a convex surface, an object side surface of the fifth lens may be a concave surface or a convex surface. An image side surface of the sixth lens is a convex lens, an object side surface and an image side surface of the seventh lens are both concave surfaces. An object side surface and an image side surface of the eighth lens are both convex surfaces. The sixth lens and the seventh lens are cemented into a cemented body.

In the embodiments of the disclosure, the cemented body may be considered as a doublet having a concave image side surface S13.

The lens group satisfies the following expression:

−0.4<r₁₃/f₁₃+r₁₄/f₁₄<−0.1; (1)

where r₁₃ represents a curvature radius of the image side surface of the seventh lens, r₁₄ represents a curvature radius of the object side surface of the eighth lens, f₁₃ represents a focal length of the image side surface the seventh lens, f₁₄ represents a focal length of the object side surface of the eighth lens.

Further, in some embodiments, the lens group satisfies the following expressions:

0<f₂/f_{L1}+f₄/f_{L2}+f₅/f_{L3}<3; (2)

|r₄/f₄+r₅/f₅|<1; (3)

where f₂ represents a focal length of the image side surface of the first lens, f₄ represents a focal length of the image side surface of the second lens, f₅ represents a focal length of the object side surface of the third lens, f_{L1} represents a focal length of the first lens, f_{L2} represents a focal length of the second lens, f_{L3} represents a focal length of the third lens, r₄ represents a curvature radius of the image side surface of the second lens, r₅ represents a curvature radius of the object side surface of the third lens.

Satisfying the above expressions may improve the capability of receiving light beams of the first lens, the second lens, and the third lens, effectively reduce the incident angle of the incident light beams, facilitate next lenses of the system to effectively correct the aberration, and benefit the reduction of the volume of the rear end of the lens group. The sum of the curvature radius of the image side surface of the second lens and the object side surface of the third lens is controlled to be close to zero while satisfying the expression (2), it means that the image side surface of the second lens and the object side surface of the third lens bend towards opposite directions, which may effectively reduce the total length of the lens group. Satisfying the above expressions (2) and (3) may significantly reduce the whole volume of the lens group, reduce the size of the camera, and effectively cut the costs.

In some embodiments, in order to control the length of the lens group, the lens group satisfies the expression:

TTL/BFL<6; (4)

where TTL represents an optical total length of the lens group, BFL represents a distance from a vertex of the image side surface of the eighth lens to the imaging plane.

In some embodiments, in order to control the distortion of the lens group effectively, the lens group satisfies the following expression:

θ/IH²<0.25; (5)

where θ represents a half-FOV of the lens group, IH represents an image height of the lens group at the half-FOV θ.

Satisfying the above expression (5), the lens group may have positive distortion, it indicates that the lens group has a higher image height at the margin field. After stretching captured pictures, it makes the margin field may have better imaging effects.

In some embodiments, in order to correct the field curvature of the lens group, the refractive powers of the third lens and the fourth lens may be controlled to meet the following expression:

−5<f₅/f_{L3}−f₇/f_{L4}<0; (6)

where f₅ represents a focal length of the object side surface of the third lens, f₇ represents a focal length of the object side surface of the fourth lens, f_{L3} represents a focal length of the third lens, f_{L4} represents a focal length of the fourth lens.

In some embodiments, for the sake of correcting the secondary spectrum and improving the resolution in short-wave direction, the fifth lens and the sixth lens need to satisfy the following expressions:

−1<f₁₀/f_{L5}+f₁₂/f_{L6}<1; (7)

|ΔPg,F₅|+|ΔPg,F₆|>0.02; (8)

where f₁₀ represents a focal length of the image side surface of the fifth lens, f₁₂ represents a focal length of the image side surface of the sixth lens, f_{L5} represents a focal length of the fifth lens, f_{L6} represents a focal length of the sixth lens, ΔPg,F₅ represents a deviation value that a relative partial dispersion of the fifth lens deviates from the Abbe empirical formula, ΔPg,F₆ represents a deviation value that a relative dispersion of the sixth lens deviates from the Abbe empirical formula.

The relative partial dispersion of the fifth lens and the sixth lens deviates from the Abbe empirical formula greatly, which is conducive to the correction of the secondary spectrum, and enables the imaging system may have better imaging effects in a relatively wide range of visible light.

In some embodiments, the lens group satisfies the following expressions:

0<r₁₂/f_{L67}<0.5; (9)

Vd₆−Vd₇>35; (10)

where r₁₂ represents a curvature radius of a cemented surface of a cemented body formed by the sixth lens and the seventh lens, f_{L67} represents a focal length of the cemented body formed by the sixth lens and the seventh lens. Vd₆ represents an Abbe number of the sixth lens, Vd₇ represents an Abbe number of the seventh lens.

Satisfying the above conditions, the difference of the Abbe numbers of the positive lens (i.e., the sixth lens) and the negative lens (i.e., the seventh lens) is greater than 35, which may effectively correct the chromatic aberration of the lens group. Meanwhile, controlling the curvature radius of a cemented surface of the cemented body formed by the sixth lens and the seventh lens, may effectively reduce the lateral chromatic aberration at the margin field.

In some embodiments, the first lens, the second lens, the third lens, the fourth lens, the fifth lens, the sixth lens, the seventh lens, and the eighth lens of the lens group are all glass lenses. The fourth lens has a positive refractive power and uses glass materials with high refractivity, which is conducive to the reduction of the spherical aberration and the axial chromatic aberration. Since each lens is a glass lens, the lens group may have good thermostability and mechanical strength, which is beneficial to work in extreme environments such as high temperature, high pressure, cold and the like.

In some embodiments, the second lens and the eighth lens are glass aspherical lenses. The second lens being a glass aspherical lens, is mainly configured for correcting the distortion. The eighth lens being a glass aspherical lens, may effectively eliminate the influences of the spherical aberration on performances of the lens group and control the exit angle of the main rays. The first lens, the sixth lens, and the seventh lens being glass spherical lenses, may effectively correct the chromatic aberration.

In some embodiments, the image side surface of the fourth lens is a concave surface, and the object side surface of the fifth lens is a convex surface.

In some embodiments, the image side surface of the fourth lens is a convex surface, and the object side surface of the fifth lens is a concave surface.

In some embodiments, the image side surface of the fourth lens is a convex surface, and the object side surface of the fifth lens is a convex surface.

In some embodiments, the lens group satisfies the expressions:

D₁>D₂>D₃; (11)

D₈>D₇>D₅; (12)

where D₁ represents the maximum diameter of the first lens, D₂ represents the maximum diameter of the second lens, D₃ represents the maximum diameter of the third lens, D₅ represents the maximum of the fifth lens, D₇ represents the maximum diameter of the seventh lens, D₈ represents the maximum diameter of the eighth lens.

In some embodiments, the disclosure further provides an imaging device, which includes the lens group of any one of the above embodiments and an imaging element. The imaging element is configured to convert optical images formed by the lens group into electrical signals.

Satisfying the configurations of all embodiments above is conducive to ensure that the lens group has advantages such as high resolution, large FOV, small distortion, and the like, meanwhile the aberration at the margin field and the secondary spectrum of the whole imaging plane can be effectively corrected, thereby improving the resolution at the margin of the lens group, and making the lens group have good imaging capability while reaching 24 million pixels. The lens group has relatively high thermostability and mechanical strength, and is suitable to work in extreme environments. Since the seventh lens and the eighth lens are close to the imaging plane, the ghost, occurred by lights reflected by the seventh lens and the eight lens, may be easily focused on the imaging plane. The disclosure may effectively eliminate the ghost occurred by the secondary reflection of the seventh lens and the eighth lens, and can reduce the occurrence of the ghost.

The shapes of aspherical surfaces of the lens group in each embodiment in the disclosure meets the following equation:

$$z = \frac{{ch}^{2}}{1 + \sqrt{1 - ( 1 + K ) {c}^{2} {h}^{2}}} + {Bh}^{2} + {Ch}^{6} + {Dh}^{8} + {Eh}^{10} + {Fh}^{12} ; \qquad ( 13 )$$

where z represents a distance from a point on a curved surface to a vertex of the curved surface in a direction of an optical axis, c represents a curvature of the vertex of the curved surface, K represents a quadratic curved surface coefficient, h represents a distance between the optical axis to the curved surface. B, C, D, E, and F respectively represent fourth, sixth, eighth, tenth, and twelfth order curved surface coefficients.

In each of the following embodiments, the thickness, the curvature radius, the material of every lens in the lens group is different, specific difference can be seen in parameters table of every embodiment.

### First Embodiment

Please refer to FIG. 1, a first embodiment of the disclosure provides a lens group 100. From an object side to an imaging plane, the lens group 100 sequentially includes a first lens L1, a second lens L2, a third lens L3, a fourth lens L4, a stop ST, a fifth lens L5, a sixth lens L6, a seventh lens L7, an eighth lens L8, and an optical filter G1.

The first lens L1 has a negative refractive power. An object side surface S1 of the first lens L1 is a convex surface, an image side surface S2 of the first lens L1 is a concave surface. The first lens L1 is a glass spherical lens.

The second lens L2 has a negative refractive power. An object side surface S3 of the second lens L2 is a convex surface, an image side surface S4 of the second lens L2 is a concave surface. The second lens L2 is a glass aspherical lens.

The third lens L3 has a negative refractive power. An object side surface S5 and an image side surface S6 of the third lens L3 are both concave surfaces. The third lens L3 is a glass spherical lens. In the other embodiments of the disclosure, the third lens L3 may also be a glass aspherical lens.

The fourth lens L4 has a positive refractive power, an object side surface S7 and an image side surface S8 of the fourth lens L4 are both convex surfaces. The fourth lens L4 is a glass aspherical lens. In the other embodiments of the disclosure, the fourth lens L4 may also be a glass spherical lens.

The fifth lens L5 has a positive refractive power. An object side surface S9 of the fifth lens L5 is a concave surface, an image side surface S10 of the fifth lens L5 is a convex surface. The fifth lens L5 is a glass spherical lens. In the other embodiments of the disclosure, the fifth lens L5 may also be a glass aspherical lens.

The sixth lens L6 has a positive refractive power, an object side surface S11 and an image side surface S12-1 of the sixth lens L6 are both convex surfaces.

The seventh lens L7 has a negative refractive power, an object side surface S12-2 and an image side surface S13 of the seventh lens L7 are both concave surfaces. The sixth lens L6 and the seventh lens L7 are both glass spherical lenses and form a cemented body, that is, the image side surface S12-1 of the sixth lens L6 and the object side surface S12-2 of the seventh lens L7 are in contact with seamlessly, thereby forming a cemented surfaces S12.

The eighth lens L8 has a positive refractive power, an object side surface S14 and an image side surface S15 of the eighth lens L8 are both convex surfaces, the eighth lens is glass a spherical lens.

The stop ST is disposed between the fourth lens L4 and the fifth lens L5. The optical filter G1 is disposed between the eighth lens L8 and the imaging plane 8.

Related parameters of every lens of the lens group 100 in this embodiment are shown in Table 1.

TABLE 1

| Surface No. | Surface type | Curvature radius (mm) | Thickness (mm) | Refractivity | Abbe number |
|---|---|---|---|---|---|
| Object surface | Object surface | Infinity | — | | |
| S1 | Spherical surface | 9.634007 | 0.569604 | 1.901 | 37.05 |
| S2 | Spherical surface | 3.001784 | 1.280843 | | |
| S3 | Aspherical surface | 7.121088 | 0.456613 | 1.497 | 81.52 |
| S4 | Aspherical surface | 2.831167 | 1.908828 | | |
| S5 | Spherical surface | −3.729674 | 0.466270 | 1.593 | 68.53 |
| S6 | Spherical surface | 50.862748 | 0.088212 | | |
| S7 | Aspherical surface | 4.594279 | 1.577177 | 1.851 | 40.10 |
| S8 | Aspherical surface | −8.094202 | 0.608283 | | |
| ST | Stop | Infinity | 0.182425 | | |
| S9 | Spherical surface | −31.591016 | 1.236848 | 1.729 | 54.67 |
| S10 | Spherical surface | −4.076586 | 0.109571 | | |
| S11 | Spherical surface | 23.615648 | 2.017297 | 1.593 | 68.53 |
| S12 | Spherical surface | −2.260257 | 0.467795 | 1.741 | 27.76 |
| S13 | Spherical surface | 7.065731 | 0.671161 | | |
| S14 | Aspherical surface | 7.584871 | 2.863905 | 1.497 | 81.52 |
| S15 | Aspherical surface | −4.252406 | 2.033598 | | |
| S16 | Spherical surface | Infinity | 0.500000 | 1.517 | 64.21 |
| S17 | Spherical surface | Infinity | 0.966386 | | |
| S18 | Imaging plane | Infinity | — | | |

Parameters of aspherical surfaces of every lens of this embodiment are shown in Table 2.

TABLE 2

| Surface No. | K | B | C | D | E | F |
|---|---|---|---|---|---|---|
| S3 | 4.971779 | 1.461059E−02 | −4.090621E−03 | 6.559685E−04 | −5.963265E−05 | 2.047671E−06 |
| S4 | 0.015529 | 1.543403E−02 | −4.350183E−03 | 2.115863E−04 | 1.132797E−04 | −2.085316E−05 |
| S7 | 0.635836 | −1.819086E−03 | −6.468468E−05 | 1.284118E−04 | −2.895705E−05 | 0.000000E+00 |
| S8 | −14.795954 | 2.539665E−03 | 6.908915E−04 | 5.386831E−05 | −1.693080E−05 | 0.000000E+00 |
| S14 | 3.093877 | −2.568246E−03 | 5.997558E−05 | −1.689094E−05 | 1.173938E−06 | −5.639561E−08 |
| S15 | −1.085548 | 1.831410E−03 | −1.568084E−04 | 6.932236E−06 | −8.484864E−07 | 2.602898E−08 |

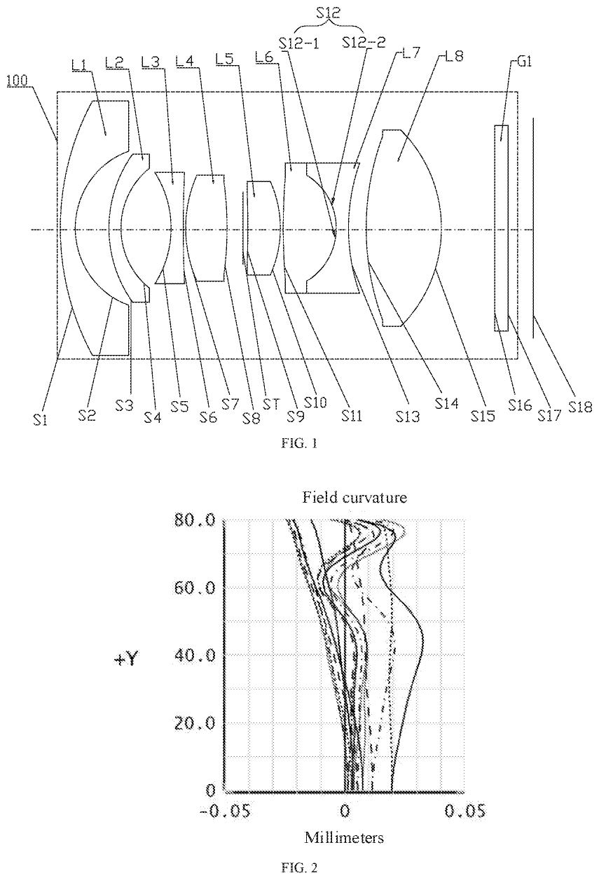

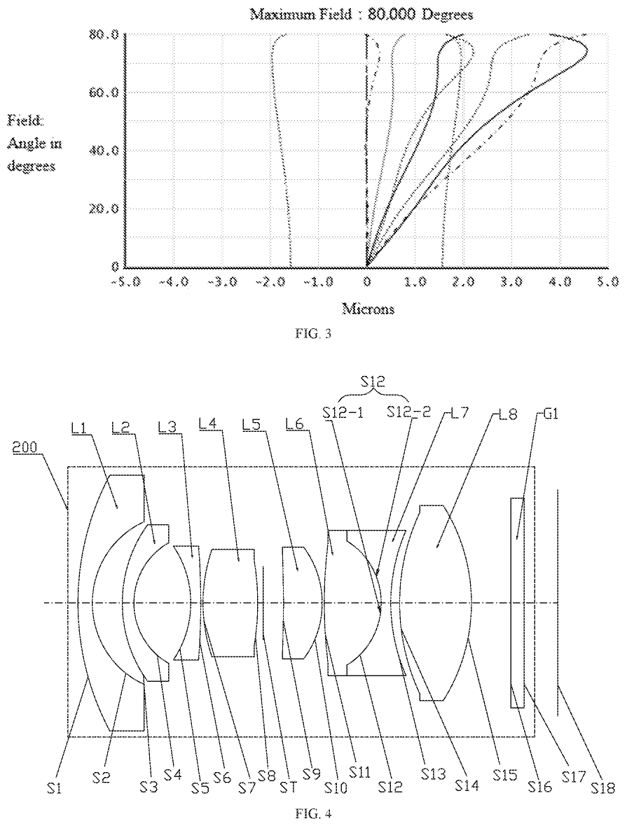

In this embodiment, the field curvature and the lateral chromatic aberration are respectively shown in FIG. 2 and FIG. 3. As can be seen in FIG. 2 and FIG. 3 the field curvature and the lateral chromatic aberration in this embodiment can be well corrected.

### Second Embodiment

Please refer to FIG. 4, which is a schematic structural diagram of a lens group 200 according to this embodiment. The lens group 200 in this embodiment is substantially similar to the lens group 100 in the first embodiment except that: an image side surface S6 of a third lens L3 of the lens group 200 in this embodiment is a convex surface, and the curvature radius and materials of each lens are different from that of the lens group 100 of the first embodiment.

Related parameters of every lens of the lens group 200 in this embodiment are shown in Table 3.

TABLE 3

| Surface No. | Surface type | Curvature radius (mm) | Thickness (mm) | Refractivity | Abbe number |
|---|---|---|---|---|---|
| Object surface | Object surface | Infinity | — | | |
| S1 | Spherical surface | 9.705422 | 0.540100 | 1.904 | 31.32 |
| S2 | Spherical surface | 3.236027 | 1.123044 | | |
| S3 | Aspherical surface | 4.694631 | 0.436021 | 1.497 | 81.52 |
| S4 | Aspherical surface | 2.169337 | 2.133758 | | |
| S5 | Spherical surface | −3.623174 | 0.374719 | 1.517 | 64.21 |
| S6 | Spherical surface | −25.760585 | 0.083910 | | |
| S7 | Aspherical surface | 6.448480 | 2.050209 | 1.882 | 37.22 |
| S8 | Aspherical surface | −7.141979 | 0.208542 | | |
| ST | Stop | Infinity | 0.756226 | | |
| S9 | Spherical surface | −51.674086 | 1.456084 | 1.497 | 81.59 |
| S10 | Spherical surface | −3.329810 | 0.077602 | | |
| S11 | Spherical surface | 17.262198 | 2.135196 | 1.603 | 65.46 |
| S12 | Spherical surface | −2.634046 | 0.358236 | 1.741 | 27.76 |
| S13 | Spherical surface | 6.413126 | 0.331165 | | |
| S14 | Aspherical surface | 6.016276 | 2.695215 | 1.497 | 81.52 |
| S15 | Aspherical surface | −6.468511 | 1.472662 | | |
| S16 | Spherical surface | Infinity | 0.500000 | 1.517 | 64.21 |
| S17 | Spherical surface | Infinity | 1.267325 | | |
| S18 | Imaging plane | Infinity | — | | |

Parameters of aspherical surfaces of every lens in this embodiment are shown in Table 4.

TABLE 4

| Surface No. | K | B | C | D | E | F |
|---|---|---|---|---|---|---|
| S3 | 1.042861 | 1.115962E−03 | −1.203794E−03 | 2.146674E−04 | −2.469422E−05 | 1.051149E−06 |
| S4 | −0.556378 | 4.396269E−03 | −1.179193E−03 | 1.265761E−04 | 2.501816E−05 | −6.645379E−06 |
| S7 | 1.277388 | −1.797997E−04 | 6.619092E−04 | −2.815272E−04 | 9.760870E−05 | −1.127427E−05 |
| S8 | 16.054237 | 1.095005E−02 | 1.015980E−03 | 1.041762E−03 | −5.341532E−04 | 1.716829E−04 |
| S14 | 1.570167 | −3.939323E−03 | 2.095508E−04 | −3.898139E−05 | 2.967899E−06 | −1.103004E−07 |
| S15 | −1.443107 | 6.424655E−04 | −1.614767E−04 | 2.513983E−05 | −3.042518E−06 | 1.116613E−07 |

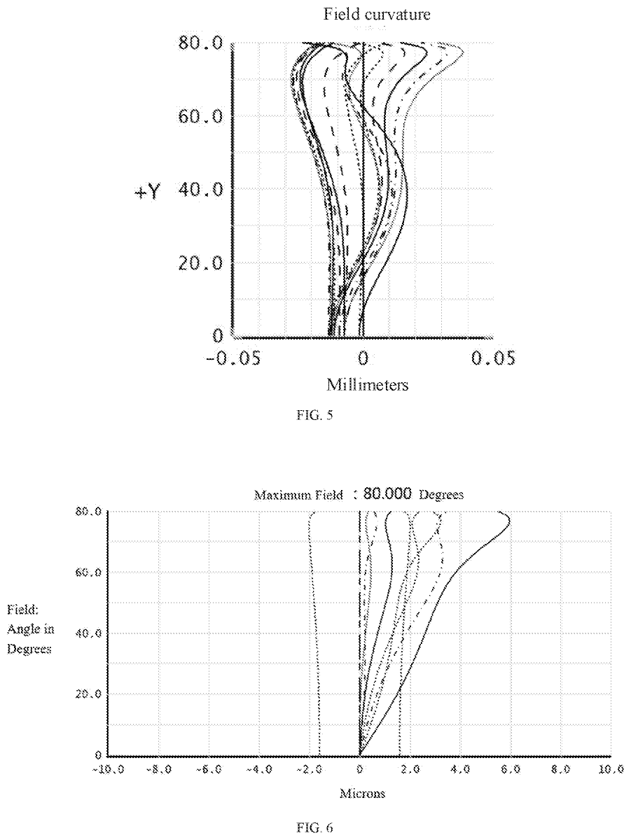

In this embodiment, the field curvature and the lateral chromatic aberration are respectively shown in FIG. 5 and FIG. 6. As can be seen in FIG. 5 and FIG. 6, the field curvature and the lateral chromatic aberration in this embodiment can be well corrected.

### Third Embodiment

Please refer to FIG. 7, which is a schematic structural diagram of a lens group 300 provided by this embodiment. The les group 300 in this embodiment is substantially similar to the lens group 100 in the first embodiment except that: an image side surface S6 of a third lens L3 of the lens group 300 in this embodiment is a convex surface, an object side surface S7 of a fourth lens is a convex lens, and the curvature radius and the materials of each lens are different from that of the lens group 100 of the first embodiment.

Related parameters of every leas of the lens group 300 in this embodiment are shown in Table 5.

TABLE 5

| Surface No. | Surface type | Curvature radius (mm) | Thickness (mm) | Refractivity | Abbe number |
|---|---|---|---|---|---|
| Object surface | Object surface | Infinity | — | | |
| S1 | Spherical surface | 9.123956 | 0.540100 | 1.904 | 31.32 |
| S2 | Spherical surface | 3.030178 | 1.018924 | | |
| S3 | Aspherical surface | 3.791971 | 0.436021 | 1.497 | 81.52 |
| S4 | Aspherical surface | 2.020961 | 2.117802 | | |
| S5 | Spherical surface | −3.414592 | 0.397647 | 1.517 | 64.21 |
| S6 | Spherical surface | −23.180738 | 0.083910 | | |
| S7 | Aspherical surface | 6.899643 | 1.933898 | 1.882 | 37.22 |
| S8 | Aspherical surface | −7.113365 | 0.166408 | | |
| ST | Stop | Infinity | 0.887439 | | |
| S9 | Spherical surface | 46.982241 | 1.517769 | 1.497 | 81.59 |
| S10 | Spherical surface | −3.655573 | 0.077602 | | |
| S11 | Spherical surface | 17.368728 | 2.277265 | 1.603 | 65.46 |
| S12 | Spherical surface | −2.668624 | 0.398543 | 1.741 | 27.76 |
| S13 | Spherical surface | 6.641187 | 0.305699 | | |
| S14 | Aspherical surface | 5.832288 | 2.751326 | 1.497 | 81.52 |
| S15 | Aspherical surface | −6.289885 | 1.472662 | | |
| S16 | Spherical surface | Infinity | 0.500000 | 1.517 | 64.21 |
| S17 | Spherical surface | Infinity | 1.117053 | | |
| S18 | Imaging plane | Infinity | — | | |

Parameters of aspherical surfaces of every lens in this embodiment are shown in Table 6.

TABLE 6

| Surface No. | K | B | C | D | E | F |
|---|---|---|---|---|---|---|
| S3 | 0.664202 | 6.464217E−04 | −2.196480E−03 | 3.710507E−04 | −3.199023E−05 | 6.110409E−07 |
| S4 | −0.609649 | 3.935584E−03 | −2.285918E−03 | 4.123722E−07 | 1.557879E−04 | −2.192370E−05 |
| S7 | 2.123439 | 5.491370E−04 | −2.898332E−04 | 2.961012E−04 | −6.438779E−05 | 4.882019E−06 |
| S8 | 13.485223 | 9.520600E−03 | 9.845544E−04 | 2.750984E−04 | −2.696162E−05 | 2.314895E−05 |
| S14 | 1.146551 | −3.236939E−03 | 1.968840E−05 | −8.106360E−07 | −4.030285E−07 | 7.827139E−09 |
| S15 | −4.217309 | 7.261631E−04 | −2.386347E−04 | 2.645390E−05 | −2.220062E−06 | 6.314089E−08 |

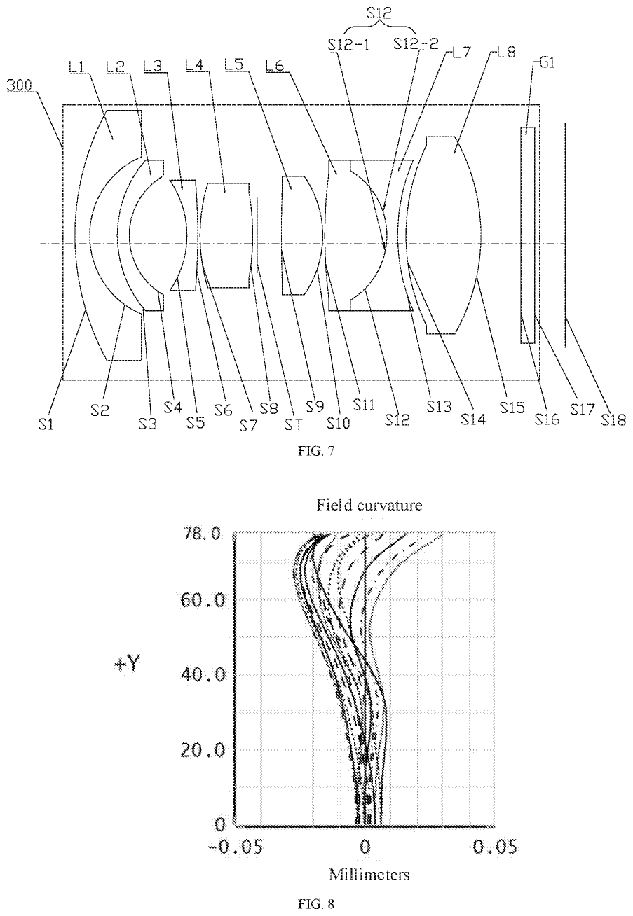

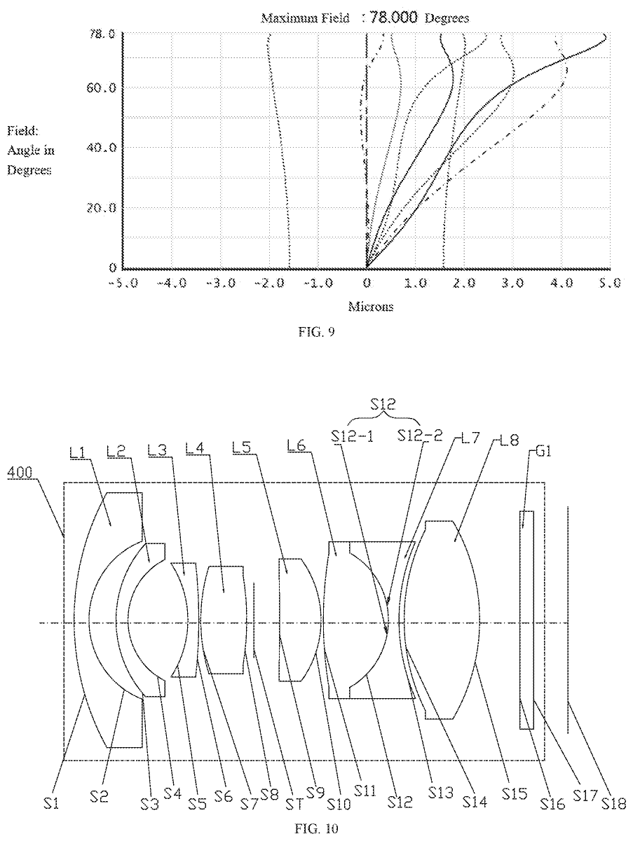

In this embodiment, the field curvature and the lateral chromatic aberration are respectively shown in FIG. 8 and FIG. 9. As can the seen in FIG. 8 and FIG. 9, the field curvature and the lateral chromatic aberration in this embodiment can be well corrected.

### Fourth Embodiment

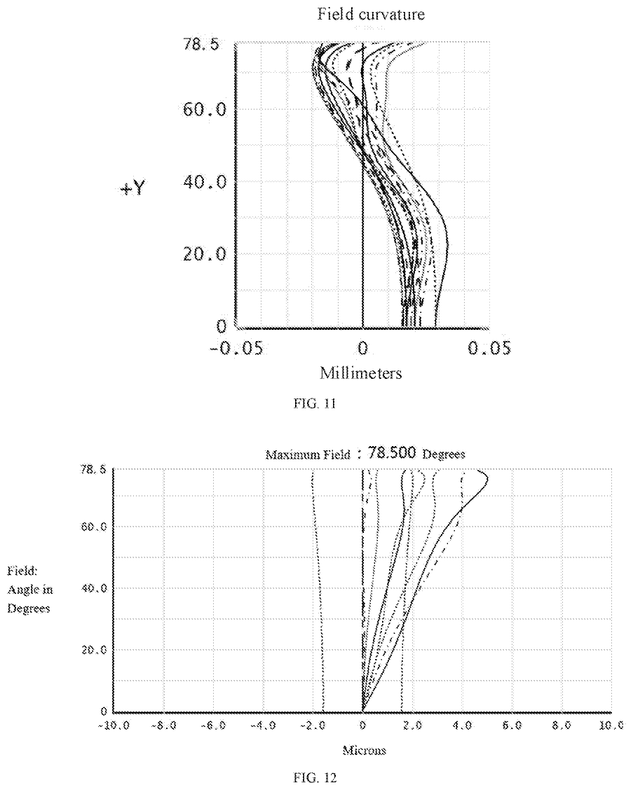

Please refer to FIG. 10 which is a schematic structural diagram of a lens group 400 provided by this embodiment. The lens group 400 in this embodiment is substantially similar to the lens group 100 in the first embodiment except that: an image side surface S6 of a third lens L3 of the lens group 400 in this embodiment is a convex surface, and a fifth lens L5 is a glass aspherical lens, and the curvature radius and the materials of each lens are different from that of the lens group 100 of the first embodiment.

Related parameters of every lens in the lens group 400 in this embodiment are shown in Table 7.

TABLE 7

| Surface No. | Surface type | Curvature radius (mm) | Thickness (mm) | Refractivity | Abbe number |
|---|---|---|---|---|---|
| Object surface | Object surface | Infinity | — | | |
| S1 | Spherical surface | 9.119022 | 0.540100 | 1.904 | 31.32 |
| S2 | Spherical surface | 2.985832 | 0.986853 | | |
| S3 | Aspherical surface | 3.923266 | 0.436021 | 1.497 | 81.52 |
| S4 | Aspherical surface | 2.081991 | 2.183508 | | |
| S5 | Spherical surface | −3.593518 | 0.396851 | 1.517 | 64.21 |
| S6 | Spherical surface | −18.043826 | 0.072887 | | |
| S7 | Aspherical surface | 7.536893 | 1.676149 | 1.882 | 37.22 |
| S8 | Aspherical surface | −7.087150 | 0.263872 | | |
| ST | Stop | Infinity | 0.933758 | | |
| S9 | Aspherical surface | −92.103190 | 1.511366 | 1.497 | 81.52 |
| S10 | Aspherical surface | −3.620990 | 0.084273 | | |
| S11 | Spherical surface | 14.120769 | 2.371232 | 1.603 | 65.46 |
| S12 | Spherical surface | −2.715116 | 0.384737 | 1.741 | 27.76 |
| S13 | Spherical surface | 6.711221 | 0.187070 | | |
| S14 | Aspherical surface | 5.719275 | 2.753736 | 1.497 | 81.52 |
| S15 | Aspherical surface | −6.180956 | 1.472662 | | |
| S16 | Spherical surface | Infinity | 0.500000 | 1.517 | 64.21 |
| S17 | Spherical surface | Infinity | 1.246227 | | |
| S18 | Imaging plane | Infinity | — | | |

Parameters of aspherical lens of every lens in this embodiment are shown in Table 8.

TABLE 8

| Surface No. | K | B | C | D | E | F |
|---|---|---|---|---|---|---|
| S3 | 0.710128 | 4.907867E−03 | −2.315601E−03 | 3.447283E−04 | −3.321111E−05 | 8.081039E−07 |
| S4 | −0.479846 | 9.571664E−03 | −2.356335E−03 | 4.913919E−05 | 1.216057E−04 | −2.355431E−05 |
| S7 | 5.383715 | 1.561208E−03 | −1.392910E−04 | 2.283968E−04 | −6.024144E−05 | 5.325632E−06 |
| S8 | 12.717831 | 1.007821E−02 | 1.278664E−03 | 1.783034E−04 | −6.678786E−05 | 3.523215E−05 |
| S9 | −48.931622 | 1.709777E−03 | −2.254490E−04 | −6.398057E−05 | −2.829654E−06 | −6.022092E−07 |
| S10 | −0.100111 | 6.686858E−04 | −1.037660E−04 | 5.120852E−07 | −1.329542E−06 | −2.020569E−06 |
| S14 | 1.021300 | −2.915414E−03 | 1.255752E−05 | −3.584221E−07 | −5.655681E−07 | 1.489444E−08 |
| S15 | −1.300251 | 1.266732E−03 | −2.043468E−04 | 2.555646E−05 | −2.048634E−06 | 4.926199E−08 |

In this embodiment, the field curvature and the lateral chromatic aberration are respectively shown in FIG. 11 and FIG. 12. As can be seen in FIG. 11 and FIG. 12 the field curvature and the lateral chromatic aberration in this embodiment can be well corrected.

### Fifth Embodiment

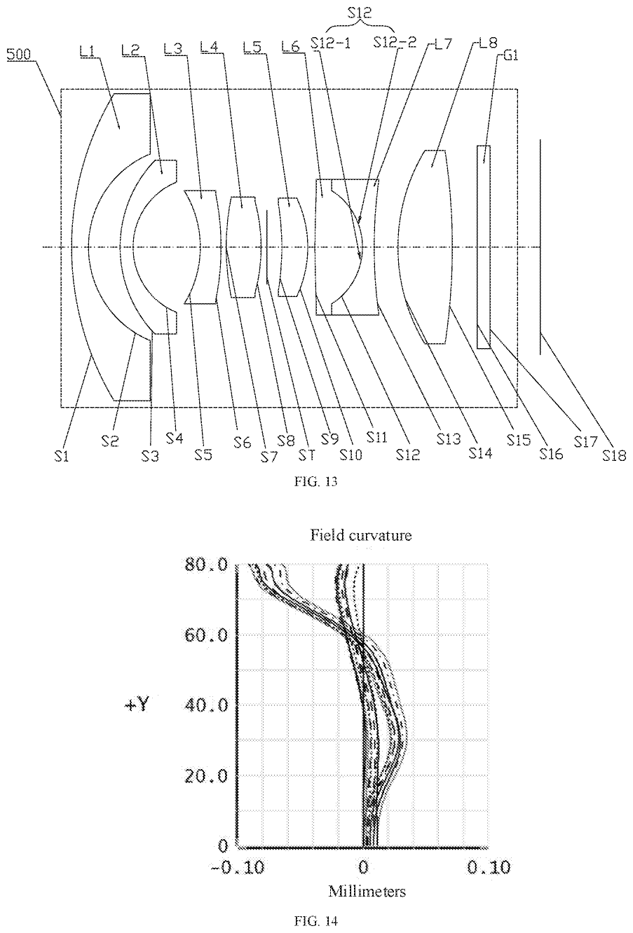

Please refer to FIG. 13, which is a schematic structural diagram of a lens group 500 provided by this embodiment. The lens group 500 in this embodiment is substantially similar to the lens group 100 in the first embodiment except that: an image side surface S6 of a third lens L3 of the lens group 500 in this embodiment is a convex surface, and the curvature radius and the materials of each lens are different from that of the lens group 100 of the first embodiment.

Related parameters of every lens in the lens group 500 in this embodiment are shown in Table 9.

TABLE 9

| Surface No. | Surface type | Curvature radius (mm) | Tickness (mm) | Refractivity | Abbe number |
|---|---|---|---|---|---|
| Object surface | Object surface | Infinity | — | | |
| S1 | Spherical surface | 10.922089 | 0.647701 | 1.665 | 54.66 |
| S2 | Spherical surface | 3.752280 | 1.213375 | | |
| S3 | Aspherical surface | 2.354419 | 0.498502 | 1.583 | 59.46 |
| S4 | Aspherical surface | 1.492589 | 2.583399 | | |
| S5 | Aspherical surface | −3.309665 | 0.798282 | 1.808 | 40.92 |
| S6 | Aspherical surface | −5.560428 | 0.196057 | | |
| S7 | Spherical surface | 9.152714 | 1.339507 | 1.806 | 41.02 |
| S8 | Spherical surface | −6.413445 | 0.219292 | | |
| ST | Stop | Infinity | 0.576095 | | |
| S9 | Spherical surface | −10.071157 | 0.998086 | 1.720 | 50.35 |
| S10 | Spherical surface | −4.216221 | 0.278200 | | |
| S11 | Spherical surface | 44.298932 | 1.823416 | 1.593 | 68.53 |
| S12 | Spherical surface | −2.480936 | 0.447741 | 1.741 | 27.76 |
| S13 | Spherical surface | 17.670037 | 0.912189 | | |
| S14 | Aspherical surface | 6.203979 | 2.091304 | 1.554 | 71.72 |
| S15 | Aspherical surface | −11.904862 | 0.953293 | | |
| S16 | Spherical surface | Infinity | 0.500000 | 1.517 | 64.21 |
| S17 | Spherical surface | Infinity | 1.929178 | | |
| S18 | Imaging plane | Infinity | — | | |

Parameters of aspherical surfaces of every lens of this embodiment are shown in FIG. 10.

TABLE 10

| Surface No. | K | B | C | D | E | F |
|---|---|---|---|---|---|---|
| S3 | 1.278726 | −1.466385E−02 | 1.103286E−03 | 3.286749E−05 | −1.049660E−05 | 4.639875E−07 |
| S4 | −0.671572 | −2.847142E−02 | 2.339156E−03 | −9.111460E−04 | 2.455079E−04 | −3.270447E−05 |
| S5 | −1.281857 | −7.182158E−04 | 1.794961E−03 | −6.906967E−04 | 1.216825E−04 | −6.123154E−06 |
| S6 | −2.755153 | 3.539590E−03 | 1.785493E−03 | −3.975897E−04 | 5.322123E−05 | 4.132465E−06 |
| S14 | 0.685100 | −2.536380E−03 | 1.667216E−04 | −8.149536E−06 | −5.023116E−09 | 1.299826E−08 |
| S15 | 3.705737 | 1.147634E−03 | −3.916835E−05 | 2.259658E−05 | −2.013499E−06 | 6.929549E−08 |

In this embodiment, thefiCldcurvatureandthelateralchromaticaberrationarrespectivelshownin FIG. 14 and FIG. 15. As can be seen in FIG. 14 and FIG. 15, the field curvature and the lateral chromatic aberration in this embodiment can be well corrected.

### Sixth Embodiment

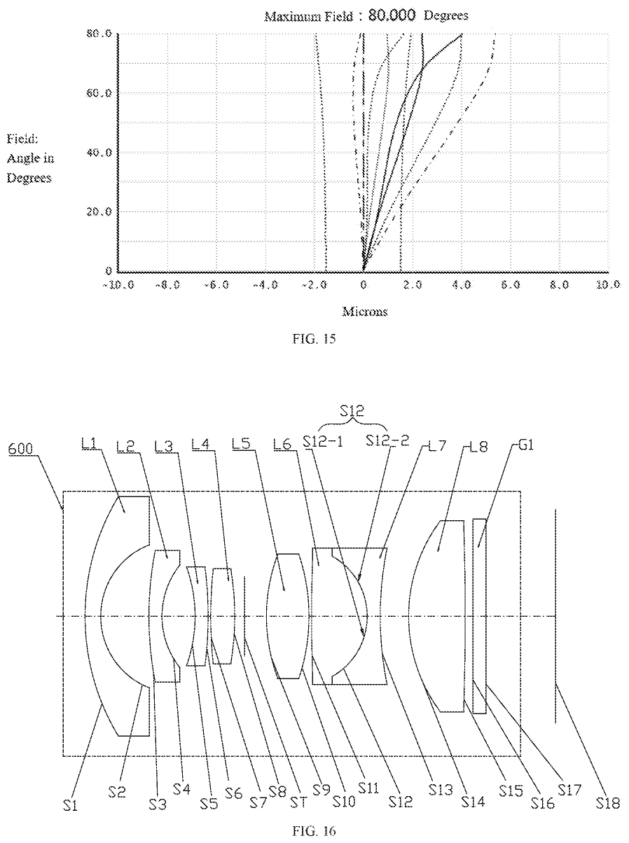

Please refer to FIG. 16, which is a schematic structural diagram of a lens group 600 provided by this embodiment. The lens group 600 in this embodiment is substantially similar to the lens group 100 in the first embodiment except that: an image side surface S6 of a third lens L3 of the lens group 600 in this embodiment is a convex surface, an object side surface S7 of a fourth lens L4 is a convex surface and the fourth lens L4 is a glass spherical lens a fifth lens L5 is glass aspherical lens, and the curvature radius and the materials of each lens are different from that of the lens group 100 of the first embodiment.

Related parameters of every lens in the lens group 600 in this embodiment are shown in Table 11.

TABLE 11

| Surface No. | Surface type | Curvature radius(mm) | Thickness (mm) | Refractivity | Abbe number |
|---|---|---|---|---|---|
| Object surface | Object surface | Infinity | — | | |
| S1 | Spherical surface | 8.416552 | 0.600000 | 1.806 | 41.02 |
| S2 | Spherical surface | 2.827889 | 1.845329 | | |
| S3 | Aspherical surface | 22.321164 | 0.500000 | 1.808 | 40.92 |
| S4 | Aspherical surface | 3.986230 | 1.267547 | | |
| S5 | Spherical surface | −5.302149 | 0.500000 | 1.497 | 81.61 |
| S6 | Spherical surface | −13.744445 | 0.100000 | | |
| S7 | Spherical surface | 16.943217 | 0.917841 | 1.904 | 31.42 |
| S8 | Spherical surface | −10.203621 | 0.379546 | | |
| ST | Stop | Infinity | 0.834209 | | |
| S9 | Aspherical surface | 7.707417 | 1.627571 | 1.774 | 49.60 |
| S10 | Aspherical surface | −5.516788 | 0.100000 | | |
| S11 | Spherical surface | 66.530658 | 2.126611 | 1.593 | 68.53 |
| S12 | Spherical surface | −2.536029 | 0.500000 | 1.806 | 25.38 |
| S13 | Spherical surface | 12.444738 | 1.084938 | | |
| S14 | Aspherical surface | 5.483823 | 2.166407 | 1.497 | 81.52 |
| S15 | Aspherical surface | −11.662485 | 0.300000 | | |
| S16 | Spherical surface | Infinity | 0.500000 | 1.517 | 64.20 |
| S17 | Spherical surface | Infinity | 2.653080 | | |
| S18 | Imaging plane | Infinity | — | | |

Parameters of aspherical surfaces of every lens of this embodiment are shown in Table 12.

TABLE 12

| Surface No. | K | B | C | D | E | F |
|---|---|---|---|---|---|---|
| S3 | 0.000000 | 8.126198E−03 | −1.643756E−03 | 1.795291E−04 | −8.249724E−06 | −2.707758E−20 |
| S4 | 0.000000 | 1.472323E−02 | −8.202346E−04 | −3.755787E−05 | 5.688442E−05 | 9.448559E−22 |
| S9 | −2.179276 | 2.149465E−03 | 2.101682E−04 | 8.555143E−06 | 2.762927E−07 | −5.024338E−21 |
| S10 | 2.737552 | 4.425689E−03 | 3.900055E−04 | 2.326582E−05 | 3.253647E−06 | −1.216996E−21 |
| S14 | 0.000000 | −1.587249E−03 | 1.125309E−04 | −4.605298E−06 | 1.608879E−07 | 1.707753E−19 |
| S15 | 0.000000 | 1.937140E−03 | 8.631786E−05 | −1.681952E−07 | 8.714511E−08 | −7.505058E−18 |

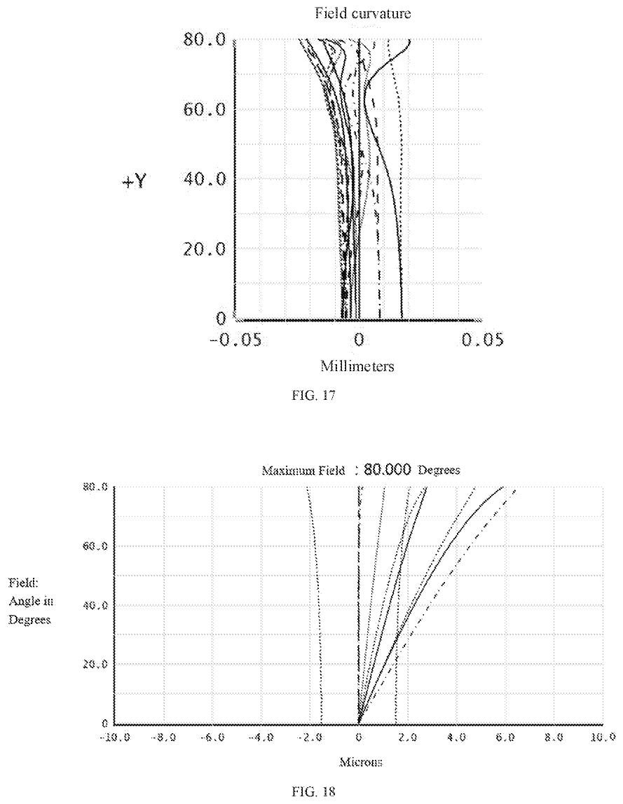

In this embodiment, the field curvature and the lateral chromatic aberration are respectively shown in FIG. 17 and FIG. 18. As can be seen in FIG. 17 and FIG. 18, the field curvature and the lateral chromatic aberration in this embodiment can be well corrected.

### Seventh Embodiment

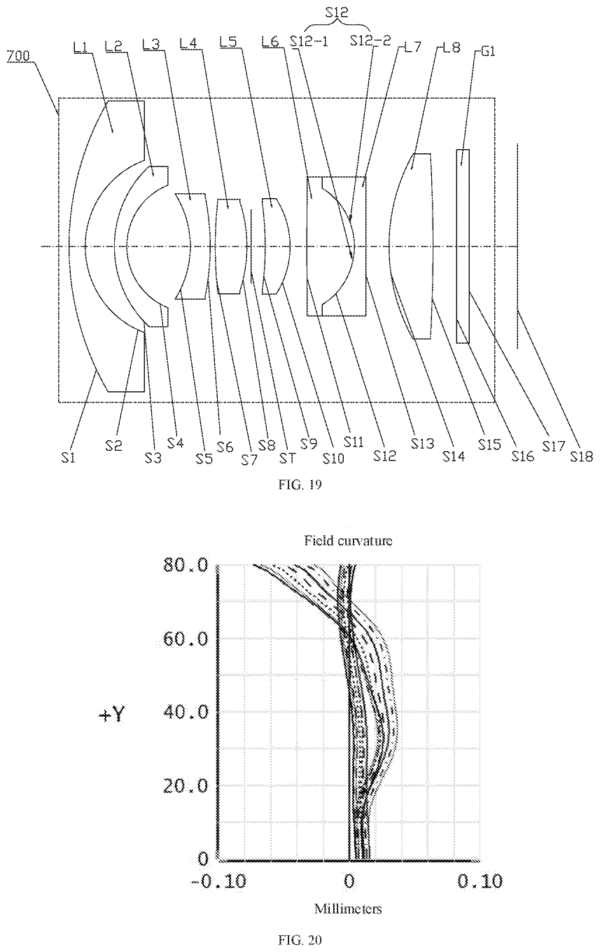

Please refer to FIG. 19, which is a schematic structural diagram of a lens group 700 provided by this embodiment. The lens group 700 in this embodiment is substantially similar to the lens group 100 in the first embodiment except that: an image side surface S6 of a third lens L3 of the lens group 700 in this embodiment is a convex surface and the third lens L3 is glass a spherical lens, fourth lens L4 is a glass spherical lens, and the curvature radius and the materials of each lens are different from that of the lens group 100 of the first embodiment.

Related parameters of every lens in the lens group 700 in this embodiment are shown in Table 13.

TABLE 13

| Surface No. | Surface type | Curvature radius (mm) | Thickness (mm) | Refractivity | Abbe number |
|---|---|---|---|---|---|
| Object surface | Object surface | Infinity | — | | |
| S1 | Spherical surface | 11.089925 | 0.649051 | 1.665 | 54.66 |
| S2 | Spherical surface | 3.571173 | 1.169993 | | |
| S3 | Aspherical surface | 2.356678 | 0.499467 | 1.583 | 59.46 |
| S4 | Aspherical surface | 1.509702 | 2.548365 | | |
| S5 | Aspherical surface | −3.208593 | 0.799744 | 1.808 | 40.92 |
| S6 | Aspherical surface | −5.292549 | 0.199305 | | |
| S7 | Spherical surface | 15.435850 | 1.274236 | 1.806 | 41.02 |
| S8 | Spherical surface | −5.550245 | 0.174101 | | |
| ST | Stop | Infinity | 0.558840 | | |
| S9 | Spherical surface | −12.632603 | 0.999465 | 1.456 | 90.27 |
| S10 | Spherical surface | −3.380778 | 0.672749 | | |
| S11 | Spherical surface | 157.528260 | 1.906853 | 1.593 | 68.53 |
| S12 | Spherical surface | −2.651287 | 0.449409 | 1.741 | 27.76 |
| S13 | Spherical surface | 283.159515 | 0.939373 | | |
| S14 | Aspherical surface | 6.479964 | 1.767962 | 1.554 | 71.72 |
| S15 | Aspherical surface | −22.693857 | 0.953293 | | |
| S16 | Spherical surface | Infinity | 0.500000 | 1.517 | 64.21 |
| S17 | Spherical surface | Infinity | 1.937846 | | |
| S18 | Imaging plane | Infinity | — | | |

Parameters of every lens of this embodiment are shown in Table 14.

TABLE 14

| Surface No. | K | B | C | D | E | F |
|---|---|---|---|---|---|---|
| S3 | −1.131668 | −1.411255E−02 | 1.103355E−03 | 2.512012E−05 | −1.040910E−05 | 5.068497E−07 |
| S4 | −0.665340 | −2.664116E−02 | 2.537162E−03 | −9.380506E−04 | 2.362648E−04 | −3.166035E−05 |
| S5 | −0.864504 | −1.611075E−03 | 2.596090E−03 | −7.767849E−04 | 1.412504E−04 | −9.007602E−06 |
| S6 | −2.047419 | 3.714210E−03 | 2.280303E−03 | −3.624365E−04 | 4.181520E−05 | 5.963318E−06 |
| S14 | 0.635266 | −2.168905E−03 | 9.949550E−05 | −4.164128E−06 | −1.330812E−07 | 1.950387E−08 |
| S15 | 13.108003 | 7.323224E−04 | −4.859952E−05 | 1.836830E−05 | −1.861831E−06 | 7.462563E−08 |

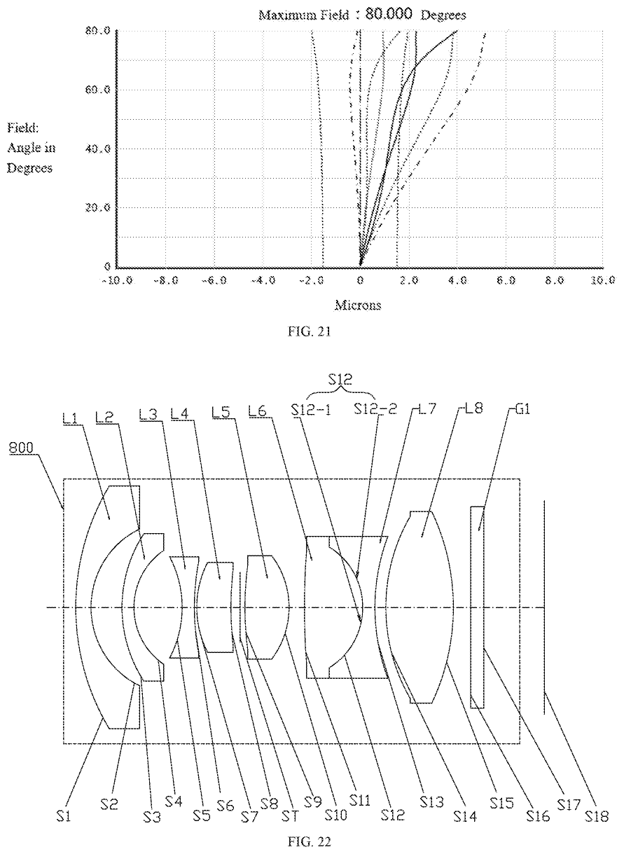

In this embodiment, the field curvature and the lateral chromatic aberration are respectively shown in FIG. 20 and FIG. 21. As can be seen in FIG. 20 and FIG. 21, the field curvature and the lateral chromatic aberration in this embodiment can ben ell corrected.

### Eighth Embodiment

Please refer to FIG. 22, which is a schematic structural diagram of a lens group 800 provided by this embodiment. The lens group 800 in this embodiment is substantially similar to the lens group 100 in the first embodiment except that: an image side surface S8 of a fourth lens L4 of the lens group 800 in this embodiment is a concave surface, an object side surface S9 of a fifth lens L5 is a convex surface, and the curvature radius and the materials of each lens are different from that of the lens group 100 of the first embodiment.

Related parameters of every lens in the lens group 800 in this embodiment are shown in Table 15.

TABLE 15

| Surface No. | Surface type | Curvature radius (mm) | Thickness (mm) | Refractivity | Abbe number |
|---|---|---|---|---|---|
| Object surface | Object surface | Infinity | — | | |
| S1 | Spherical surface | 8.588295 | 0.587171 | 1.901 | 37.05 |
| S2 | Spherical surface | 3.215063 | 1.189477 | | |
| S3 | Aspherical surface | 4.871782 | 0.456521 | 1.497 | 81.52 |
| S4 | Aspherical surface | 2.092124 | 1.853217 | | |
| S5 | Spherical surface | −3.940101 | 0.468192 | 1.593 | 68.53 |
| S6 | Spherical surface | 8.998686 | 0.090857 | | |
| S7 | Aspherical surface | 3.810407 | 1.313832 | 1.851 | 40.10 |
| S8 | Aspherical surface | 204.384445 | 0.349381 | | |
| ST | Stop | Infinity | 0.188761 | | |
| S9 | Spherical surface | 11.956060 | 1.694640 | 1.593 | 68.53 |
| S10 | Spherical surface | −3.107656 | 0.586936 | | |
| S11 | Spherical surface | 26.449892 | 2.240365 | 1.593 | 68.53 |
| S12 | Spherical surface | −2.605537 | 0.469490 | 1.717 | 29.51 |
| S13 | Spherical surface | 7.281090 | 0.417493 | | |
| S14 | Aspherical surface | 5.737610 | 2.594098 | 1.497 | 81.52 |
| S15 | Aspherical surface | −5.445476 | 0.671367 | | |
| S16 | Spherical surface | Infinity | 0.500000 | 1.517 | 64.21 |
| S17 | Spherical surface | Infinity | 2.328290 | | |
| S18 | Imaging plane | Infinity | — | | |

Parameters of every lens of this embodiment are shown in Table 16.

TABLE 16

| Surface No. | K | B | C | D | E | F |
|---|---|---|---|---|---|---|
| S3 | −4.055072 | 9.332023E−03 | −2.150432E−03 | 3.920993E−04 | 4.177465E−05 | 1.832443E−06 |
| S4 | −2.510520 | 3.389336E−02 | −4.965403E−03 | 3.833433E−04 | 1.374814E−04 | −3.975206E−05 |
| S7 | −10.218584 | 2.733635E−02 | −5.866921E−03 | 1.740687E−03 | −3.015777E−04 | 0.000000E+00 |
| S8 | −50.001313 | 1.624161E−02 | 2.451725E−04 | 1.663441E−03 | −4.796163E−04 | 0.000000E+00 |
| S14 | 0.890705 | −2.353088E−03 | 1.064430E−04 | −1.175590E−05 | 3.926168E−07 | −2.339179E−08 |
| S15 | −1.374182 | 2.555217E−03 | −7.185379E−05 | 1.247786E−05 | −1.049627E−06 | 1.288117E−08 |

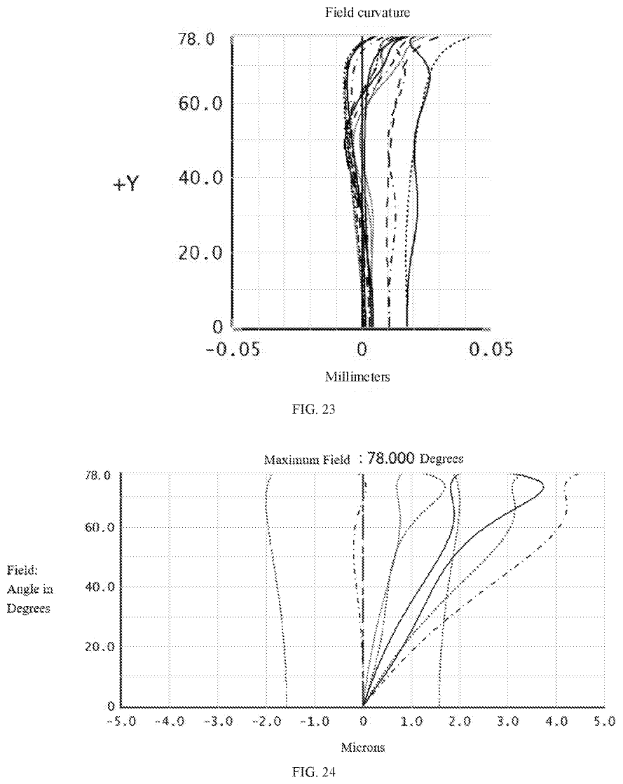

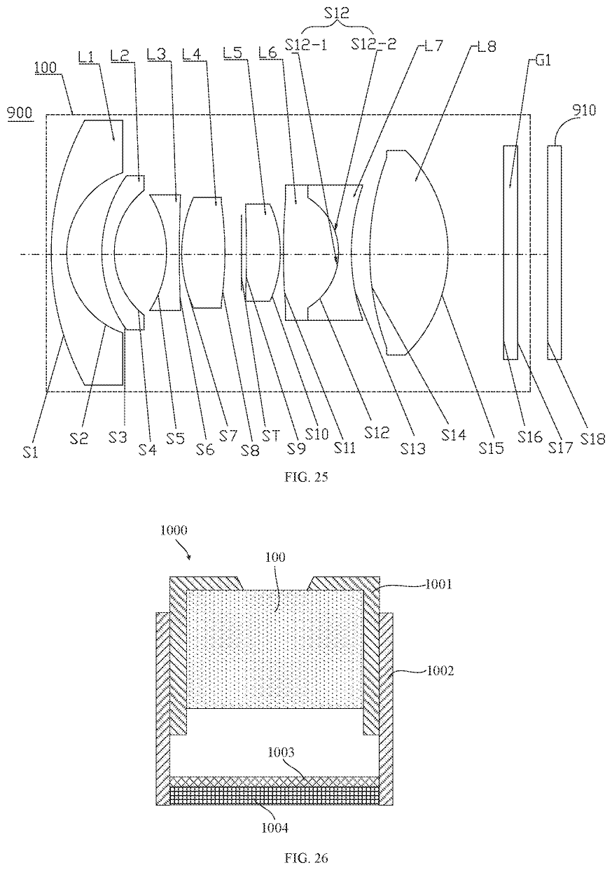

In this embodiment, the field curvature and the lateral chromatic aberration are respectively shown in FIG. 23 and FIG. 24. As can be seen in FIG. 23 and FIG. 24, the field curvature and the lateral chromatic aberration can be well corrected.

Table 17 shows the above embodiments and their corresponding optical characteristics, including the focal length f of the system, the aperture number F#, the FOV 2θ, and the optical total length TTL, and the values corresponding to each of the above expressions.

TABLE 17

| | Embodiment | Embodiment | Embodiment | Embodiment | Embodiment | Embodiment | Embodiment | Embodiment |
|---|---|---|---|---|---|---|---|---|
| Expression | 1 | 2 | 3 | 4 | 5 | 6 | 7 | 8 |
| f (mm) | 2.665 | 2.714 | 2.677 | 2.693 | 2.862 | 2.835 | 2.862 | 2.656 |
| F# | 2.477 | 2.500 | 2.480 | 2.478 | 2.400 | 2.400 | 2.400 | 2.479 |
| 20 (deg) | 160.0 | 160.0 | 156.0 | 157.0 | 160.0 | 160.0 | 160.0 | 156.0 |
| TTL (mm) | 18.0 | 18.0 | 18.0 | 18.0 | 18.0 | 18.0 | 18.0 | 18.0 |
| f₂/f_{L1} + f₄/f_{L2} + f₅/f_{L3} | 2.318 | 2.001 | 1.915 | 1.870 | 1.261 | 2.045 | 1.261 | 2.590 |
| \|r₄/f₄ + r₅/f₅\| | 0.097 | 0.021 | 0.021 | 0.021 | 0.229 | 0.317 | 0.229 | 0.097 |
| TTL/BFL | 5.144 | 5.556 | 5.826 | 5.592 | 5.323 | 5.208 | 5.308 | 5.143 |
| θ/IH² | 0.206 | 0.209 | 0.200 | 0.202 | 0.200 | 0.197 | 0.200 | 0.197 |
| r₁₃/f₁₃ + r₁₄/f₁₄ | −0.252 | −0.252 | −0.252 | −0.252 | −0.195 | −0.315 | −0.192 | −0.228 |
| f₅/f_{L3} − f₇/f_{L4} | −0.401 | −0.913 | −0.995 | −1.159 | −1.993 | −2.015 | −3.352 | −0.473 |
| f₁₀/f_{L5} + f₁₂/f_{L6} | 0.043 | 0.052 | 0.176 | 0.055 | −0.203 | 0.876 | −0.046 | 0.332 |
| \|ΔP_{g,F5}\| + \|ΔP_{g,F6}\| | 0.022 | 0.035 | 0.035 | 0.041 | 0.021 | 0.021 | 0.054 | 0.028 |
| r₁₂/f_{L67} | 0.329 | 0.341 | 0.333 | 0.304 | 0.225 | 0.361 | 0.149 | 0.322 |
| Vd₆ − Vd₇ | 40.763 | 37.698 | 37.698 | 37.698 | 40.763 | 43.145 | 40.763 | 39.015 |

Based on the above embodiments, the following optical indexes have been achieved: (1) the FOV: 2θ>155°; (2) the optical total length: TLL≤18.0 mm; (3) the applicable spectral range: 400˜700 nm.

In the optical imaging system provided by this embodiment, the first lens L1, the second lens L2, and the third lens L3 are configured for collecting lights and reducing the incident angle of the incident lights, which are beneficial to reduce the subsequent correction of the aberration by the optical system. The second lens L2 is a glass aspherical lens, which is mainly configured for correcting the distortion. The third lens L3 and the fourth lens L4 are configured for eliminating the field curvature cooperatively with each other. The fourth lens L4 uses glass materials with high refractivity, which is conducive to eliminate the spherical aberration. The relative partial dispersion of the fifth lens L5 and the sixth lens L6 deviates from the Abbe empirical formula greatly, which is benefit to correct the secondary spectrum, thereby enabling the optical system have good imaging effects in a relatively wide range of visible light. The sixth lens L6 and the seventh lens L7 form the cemented body, wherein the difference of the Abbe numbers of the positive lens and the negative lens is greater than 35, which may effectively correct the chromatic aberration. The eighth lens L8 is configured to eliminate the aberration and controlling the exit angle of the main rays. Each lens being a glass lens may enable the lens group have good thermostability and mechanical strength, and is suitable to work in extreme environments. As the seventh lens and the eighth lens are close to the imaging plane, the ghost, occurred by lights reflected by the seventh lens and the eighth lens, may be easily focused on the imaging plane. The disclosure may effectively eliminate the ghost occurred by the secondary reflection of the seventh lens and the eighth lens, and can reduce the occurrence of the ghost. Therefore, the lens group provided by the disclosure can not only well correct the aberration at the margin field and provide better imaging effects, but also has good thermostability, supersize FOV, small distortion, and other advantages, so the lens group is applicable to imaging devices such as motion cameras.

### Ninth Embodiment

Please refer to FIG. 25, which is a schematic structural diagram of an imaging device 900 provided by this embodiment. The imaging device 900 includes the lens group (e.g., the lens group 100) of any one of the above embodiments and an imaging element 910. The imaging element 910 may be a Complementary Metal Oxide Semiconductor (CMOS) image sensor or a Charge Coupled Device (CCD) image sensor.

The imaging device 900 may be a motion camera, a video camera, a driving recorder, a surveillance camera, and any other form of electric devices equipped with the lens group.

The imaging device 900 provided by this embodiment includes the lens group 100, since the lens group can not only correct the aberration thereof at the margin field and provide better imaging effects, but also has good thermostability, supersize FOV, and small distortion, the imaging device 900 has advantages such as better imaging effects, good thermostability, supersize FOV, small distortion, and the like.

### Tenth Embodiment

FIG. 26 illustrates a structural diagram of a camera module 1000. The camera module 1000 includes a barrel 1001, a holder 1002, an image sensor 1003, a printed circuit board 1004, and the lens group of any one of the foregoing embodiments. FIG. 26 takes the lens group 100 of the first embodiment as an example. The lens group 100 is mounted in the barrel 1001, the image sensor 1003 is mounted in the holder 1002, and the barrel 1001 is movably mounted on the holder 1002. The lens group 100 is configured to form an optical image. The image sensor 1003 is opposite to the lens group 100, and is configured to generate image data for the optical image sensed thereby. The image sensor 1003 may be a CMOS sensor or a CCD sensor.

It is noted that the image sensor 1003 may be mounted on the printed circuit board 1004, or may be electrically connected with a processing chip, to process the image data.

### Eleventh Embodiment

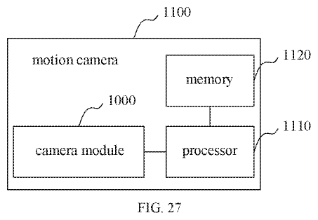

A motion camera 1100 provided by this embodiment will be described below with reference to FIG. 27. The motion camera 1100 includes the camera module 1000 described in the above embodiment, a processor 1110, and a memory 1120. The camera module 1000 is configured to capture images, the processor 1110 is configured to acquire and process image data of the captured images, the memory 1120 is configured to store the image data of the captured images.

In this embodiment, the motion camera 1100 may be applied to movable devices. In an example, the motion camera 1100 may be installed on handled devices. During sports, such as the above-mentioned skiing, surfing, parachuting, and so on, the handled devices can be held by users to take images. In another example, the motion camera 1100 may be disposed on head-mounted devices.

In yet another example, the motion camera 1100 may also be installed on a pan-tilt of an aerial vehicle to be used as an aerial camera. In yet another example, the motion camera 1100 may also be installed in vehicles. It can be understood that the motion camera 1100 may also be applied to other movable devices besides those described above, which is not limited in this application.

The above embodiments are merely illustrative of several embodiments of the present disclosure, and the description thereof is more specific and detailed, however is not to be construed as limiting the scope of the disclosure. It should be noted that various variations and modifications may be made by those skilled in the art without departing from the concept of the disclosure, which fall within the scope of protection of the present disclosure. Therefore, the scope of the disclosure should be determined by the appended claims.

What is claimed is:

1. A lens group, from an object side to an imaging plane, the lens group sequentially comprising:
a first lens with a negative refractive power, an object side surface of the first lens being a convex surface and an image side surface of the first lens being a concave surface;
a second lens with a negative refractive power, an object side surface of the second lens being a convex surface and an image side surface of the second lens being a concave surface;
a third lens with a negative refractive power, an object side surface of the third lens being a concave surface;
a fourth lens with a positive refractive power, an object side surface of the fourth lens being a convex surface;
a stop;
a fifth lens with a positive refractive power, an image side surface of the fifth lens being a convex surface;
a sixth lens with a positive refractive power, an image side surface of the sixth lens being a convex surface;
a seventh lens with a negative refractive power, an object side surface and an image side surface of the seventh lens being both concave surfaces, the sixth lens and the seventh lens being cemented into a cemented body;
an eighth lens with a positive refractive power, an object side surface and an image side surface of the eighth lens being both convex surfaces; and
an optical filter, disposed between the eighth lens and the imaging plane;
wherein the lens group satisfies the expression:
−0.4<r₁₃/f₁₃+r₁₄/f₁₄<−0.1;
where r₁₃ represents a curvature radius of the image side surface of the seventh lens, r₁₄ represents a curvature radius of the object side surface of the eighth lens, f₁₃ represents a focal length of the image side surface the seventh lens, f₁₄ represents a focal length of the object side surface of the eighth lens.

2. The lens group as claimed in claim 1, wherein the lens group satisfies the expressions:
0<f₂/f_{L1}+f₄/f_{L2}+f₅/f_{L3}<3;

|r₄/f₄+r₅/f₅|<1;
where f₂ represents a focal length of the image side surface of the first lens, f₄ represents a focal length of the image side surface of the second lens, f₅ represents a focal length of the object side surface of the third lens, f_{L1} represents a focal length of the first lens, f_{L2} represents a focal length of the second lens, f_{L3} represents a focal length of the third lens, r₄ represents a curvature radius of the image side surface of the second lens, r₅ represents a curvature radius of the object side surface of the third lens.

3. The lens group as claimed in claim 1, wherein the lens group satisfies the expression:
TTL/BFL<6:
where TTL represents a total length of the lens group, BFL represents a distance from a vertex of the image side surface of the eighth lens to the imaging plane.

4. The lens group as claimed in claim 1, wherein the lens group satisfies the expression:
θ/IH²<0.25:
wherein θ represents a half field of view of the lens group, IH represents an image height of the lens group at the half field of view θ.

5. The lens group as claimed in claim 1, wherein the lens group satisfies the expression:
−5<f₅/f_{L3}−f₇/f_{L4}<0
where f₅ represents a focal length of the object side surface of the third lens, f₇ represents a focal length of the object side surface of the fourth lens, f_{L3} represents a focal length of the third lens, f_{L4} represents a focal length of the fourth lens.

6. The lens group as claimed in claim 1, wherein the lens group satisfies the expressions:
−1<f₁₀/f_{L5}+f₁₂/f_{L6}<1

|ΔPg,F₅|+|ΔPg,F₆|>0.02;
where f₁₀ represents a focal length of the image side surface of the fifth lens, f₁₂ represents a focal length of the image side surface of the sixth lens, f_{L5} represents a focal length of the fifth lens, f_{L6} represents a focal length of the sixth lens, ΔPg,F₅ represents a deviation value that a relative partial dispersion of the fifth lens deviates from the Abbe empirical formula, ΔPg,F₆ represents a deviation value that a relative dispersion of the sixth lens deviates from the Abbe empirical formula.

7. The lens group as claimed in claim 1, wherein the lens group satisfies the expressions:
0<r₁₂/f_{L67}<0.5;
Vd₆−Vd₇>35;
where r₁₂ represents a curvature radius of a cemented surface of a cemented body formed by the sixth lens and the seventh lens, f_{L67} represents a focal length of the cemented body formed by the sixth lens and the seventh lens, Vd₆ represents an Abbe number of the sixth lens, Vd₇ represents an Abbe number of the seventh lens.

8. The lens group as claimed in claim 1, wherein the first lens, the second lens, the third lens, the fourth lens, the fifth lens, the sixth lens, the seventh lens, and the eighth lens are all glass lenses.

9. The lens group as claimed in claim 1, wherein the second lens and the eighth lens are both glass aspherical lenses, the first lens, the sixth lens, and the seventh lens are all glass spherical lenses.

10. The lens group as claimed in claim 1, wherein the image side surface of the fourth lens is a concave surface, and the object side surface of the fifth lens is a convex surface.

11. The lens group as claimed in claim 1, wherein the image side surface of the fourth lens is a convex surface, and the object side surface of the fifth lens is a concave surface.

12. The lens group as claimed in claim 1, wherein the image side surface of the fourth lens is a convex surface, and the object side surface of the fifth lens is a convex surface.

13. The lens group as claimed in claim 1, wherein the lens group satisfies the expressions:
D₁>D₂>D₃:
D₈>D₇>D₅;
where D₁ represents the maximum diameter of the first lens, D₂ represents the maximum diameter of the second lens, D₃ represents the maximum diameter of the third lens, D₅ represents the maximum of the fifth lens, D₇ represents the maximum diameter of the seventh lens, D₈ represents the maximum diameter of the eighth lens.

14. A camera module, comprising a lens group and an image sensor opposite to the lens group, wherein the lens group is configured to form an optical image, the image sensor is configured to generate image data for the optical image sensed thereby; from an object side surface to an imaging plane, the lens group sequentially comprises:
a first lens having a negative refractive power, a convex object side surface, and a concave image side surface;
a second lens having a negative refractive power, a convex object side surface, and a concave image side surface;
a third lens having a negative refractive power and a concave object side surface;
a fourth lens having a positive refractive power and a convex object side surface;
a stop;
a fifth lens having a positive refractive power and a convex image side surface;
a doublet formed by a sixth lens and a seventh lens, the sixth lens having a positive refractive power and a convex image side surface, the doublet having a concave image side surface an eighth lens having a positive refractive power, a convex object side surface, and a convex image side surface;
an optical filter, disposed between the eighth lens and the imaging element;
wherein the lens group satisfies the expression:
−0.4<r₁₃/f₁₃+r₁₄/f₁₄<−0.1;
where r₁₃ represents a curvature radius of the image side surface of the seventh lens, r₁₄ represents a curvature radius of the object side surface of the eighth lens, f₁₃ represents a focal length of the image side surface the seventh lens, f₁₄ represents a focal length of the object side surface of the eighth lens.

15. The camera module as claimed in claim 14, wherein the seventh lens has a negative refractive power, a concave object side surface, and a concave image side surface; the image side surface of the third lens is a convex surface, the image side surface of the fourth lens is a concave lens, and the object side surface of the fifth lens is a convex surface;
wherein the second lens, the third lens, the fifth lens, and the eighth lens are all glass aspherical lenses, the first lens, the fourth lens, the sixth lens, and the seventh lens are all glass spherical lenses.

16. The camera module as claimed in claim 14, wherein the lens group satisfies the expressions:
0<f₂/f_{L1}+f₄/f_{L2}+f₅/f_{L3}<3;

|r₄/f₄+r₅/f₅|<1;
−5<f₅/f_{L3}−f₇/f_{L4}<0;
−1<f₁₀/f_{L5}+f₁₂/f_{L6}<1
where f₂ represents a focal length of the image side surface of the first lens, f₄ represents a focal length of the image side surface of the second lens, f₅ represents a focal length of the object side surface of the third lens, f_{L1} represents a focal length of the first lens, f_{L2} represents a focal length of the second lens, f_{L3} represents a focal length of the third lens, r₄ represents a curvature radius of the image side surface of the second lens, r₅ represents a curvature radius of the object side surface of the third lens, f₇ represents a focal length of the object side surface of the fourth lens, f_{L4} represents a focal length of the fourth lens, f₁₀ represents a focal length of the image side surface of the fifth lens, f₁₂ represents a focal length of the image side surface of the sixth lens, f_{L5} represents a focal length of the fifth lens, f_{L6} represents a focal length of the sixth lens.

17. The camera module as claimed in claim 14, wherein the lens group satisfies the expressions:
TTL/BFL<6:
θ/IH²<0.25:
where TTL represents a total length of the lens group, BFL represents a distance from a vertex of the image side surface of the eighth lens to the imaging plane, θ represents a half field of view of the lens group, IH represents an image height of the lens group at the half field of view θ.

18. The camera module as claimed in claim 14, wherein the lens group satisfies the expressions:

|ΔPg,F₅|+|ΔPg,F₆|>0.02;
0<r₁₂/f_{L67}<0.5;
Vd₆−Vd₇>35;
where ΔPg,F₅ represents a deviation value that a relative partial dispersion of the fifth lens deviates from the Abbe empirical formula, ΔPg,F₆ represents a deviation value that a relative dispersion of the sixth lens deviates from the Abbe empirical formula, r₁₂ represents a curvature radius of a cemented surface of a cemented body formed by the sixth lens and the seventh lens, f_{L67} represents a focal length of the cemented body formed by the sixth lens and the seventh lens, Vd₆ represents an Abbe number of the sixth lens, Vd₇ represents an Abbe number of the seventh lens.

19. A motion camera, comprising a camera module, a processor, and a memory, the memory and the camera module being electrically connected with the processor, the memory being configured to store image data, the processor being configured to process the image data, the camera module comprising a wide-angle lens and an image sensor, the image sensor being opposite to the wide-angle lens and configured to sense and generate the image data,
wherein the lens group sequentially comprises:
a first lens having a negative refractive power, a convex object side surface, and a concave image side surface;
a second lens having a negative refractive power, a convex object side surface, and a concave image side surface;
a third lens having a negative refractive power and a concave object side surface;
a fourth lens having a positive refractive power and a convex object side surface;
a stop;
a fifth lens having a positive refractive power and a convex image side surface;
a sixth lens having a positive refractive power and a convex image side surface;
a seventh lens having a negative refractive power, a concave object side surface, and a concave image side surface, the sixth lens and the seventh lens being cemented into a cemented body;
an eighth lens having a positive refractive power, a convex object side surface, and a convex image side surface;
an optical filter, disposed between the eighth lens and the image sensor;
wherein the lens group satisfies the expressions:
−0.4<r₁₃/f₁₃+r₁₄/f₁₄<−0.1;
TTL/BFL<6:
θ/IH²<0.25;
where r₁₃ represents a curvature radius of the image side surface of the seventh lens, r₁₄ represents a curvature radius of the object side surface of the eighth lens, f₁₃ represents a focal length of the image side surface the seventh lens, f₁₄ represents a focal length of the object side surface of the eighth lens, TTL represents a total length of the lens group, BFL represents a distance from a vertex of the image side surface of the eighth lens to the imaging plane, θ represents a half field of view of the lens group, IH represents an image height of the lens group at the half field of view θ.

20. The motion camera as claimed in claim 19, wherein the lens group satisfies the expressions:
0<f₂/f_{L1}+f₄/f_{L2}+f₅/f_{L3}<3;

|r₄/f₄+r₅/f₅|<1;
−5<f₅/f_{L3}−f₇/f_{L4}<0;
−1<f₁₀/f_{L5}+f₁₂/f_{L6}<1

|ΔPg,F₅|+|ΔPg,F₆|>0.02;
0<r₁₂/f_{L67}<0.5;
Vd₆−Vd₇>35;
Where f₂ represents a focal length of the image side surface of the first lens, f₄ represents a focal length of the image side surface of the second lens, f₅ represents a focal length of the object side surface of the third lens, f_{L1} represents a focal length of the first lens, f_{L2} represents a focal length of the second lens, f_{L3} represents a focal length of the third lens, r₄ represents a curvature radius of the image side surface of the second lens, r₅ represents a curvature radius of the object side surface of the third lens, f₇ represents a focal length of the object side surface of the fourth lens, f_{L4} represents a focal length of the fourth lens, f₁₀ represents a focal length of the image side surface of the fifth lens, f₁₂ represents a focal length of the image side surface of the sixth lens, f_{L5} represents a focal length of the fifth lens, f_{L6} represents a focal length of the sixth lens, ΔPg,F₅ represents a deviation value that a relative partial dispersion of the fifth lens deviates from the Abbe empirical formula, ΔPg,F₆ represents a deviation value that a relative dispersion of the sixth lens deviates from the Abbe empirical formula, r₁₂ represents a curvature radius of a cemented surface of a cemented body formed by the sixth lens and the seventh lens, f_{L67} represents a focal length of the cemented body formed by the sixth lens and the seventh lens, Vd₆ represents an Abbe number of the sixth lens, Vd₇ represents an Abbe number of the seventh lens.
